(19) United States
(12) Patent Application Publication
(10) Pub. No.: US 2013/0025706 A1
(43) Pub. Date: Jan. 31, 2013

(54) SYSTEM AND PROCESS FOR DELIVERING BUILDING MATERIALS

(71) Applicants: Stephen DEGARAY, Huntington, NY (US); Peter LARSEN, Farum (DK)

(72) Inventors: Stephen DEGARAY, Huntington, NY (US); Peter LARSEN, Farum (DK)

(73) Assignee: SBS PRODUCT TECHNOLOGIES, LLC, PORT WASHINGTON, NY (US)

(21) Appl. No.: 13/552,927

(22) Filed: Jul. 19, 2012

Related U.S. Application Data
(60) Provisional application No. 61/509,749, filed on Jul. 20, 2011.

(51) Int. Cl. F17D 1/00; B65G 53/40

(52) U.S. Cl. 137/351; 406/108

(57) ABSTRACT

A system and process for mixing and distributing building materials. This system and process can also include a way or a means for calibrating the mixing of these materials.

### CROSS REFERENCE TO RELATED APPLICATIONS

This application is a non-provisional application that hereby claims priority under 35 U.S.C. 119e from provisional application Ser. No. 61/509,749 filed on Jul. 20, 2011, the disclosure of which is hereby incorporated herein by reference in its entirety.

### BACKGROUND OF THE INVENTION

One embodiment of the invention relates to a system and process for delivering building materials. This type of device is capable of performing a continuous process of feeding materials to a building site in both a batch and continuous flow process.

### SUMMARY OF THE INVENTION

One embodiment of the invention relates to a process for continuously feeding building materials to a building site.

This process comprises feeding a first type of material through a feeding system and then feeding a second type of material through the feeding system. This process also includes mixing said first type of material with a second type of material into a composite material. This process can also include mixing a third type of material with the composite material. This third type of material can be a liquid material such as water, a water chemical mixture or any other type of third material. A next step can include pumping the mixed material to a building site. This process further comprises the step of moving a test batch of at least one type of material through the feeding system to calibrate the feeding rate. This process can also comprise the step of calibrating the feeding system by moving a test batch of at least a second type of material through the feeding system. This process can also include the step of re-feeding the previously fed test batch of material back into the feeding system. This process can also include the step of feeding the second type of test batch material back into the feeding system.

In at least one embodiment, the step of calibrating the feeding system comprises determining a first weight for a material to be mixed, moving the material through the feeding system, tracking the time for feeding the material through the system and then determining a second weight for the material to be mixed.

At least one embodiment of the invention can relate to a system for delivering building materials comprising a container, a transport device coupled to the container, wherein the transport device is configured to couple to a vehicle. In this case, the transport device can in this or in any embodiment be a flat bed for a truck. In addition, the container can be in the form of a standard sized container for a standard sized truck such as an eighteen wheel truck.

Inside of the container there can be a first holding bin substantially disposed in the container. In addition, there can be a second holding bin substantially disposed in the container. There can be at least one feed tube coupled to the first holding bin. This feed tube can include a drive system to feed the material through the feed tube. The drive system can be in the form of any known drive system, but in this case can be in the form of a screw drive system. There can be at least one other feed tube coupled to the second holding bin, this other feed tube can also comprise a drive system. This type of drive system can be of any known drive system, such as in the form of a screw drive system. There can be at least one pre-mixer configured to receive materials from at least one of the feed tubes coupled to the first holding bin. There can also be at least one feed tube coupled to the second holding bin.

There can also be at least one continuous mixer, configured to receive an output of the pre-mixer and configured to hold the components from the pre-mixer.

In at least one embodiment, the transport device comprises a flat bed with a connection element configured to connect to the vehicle and wherein this vehicle comprises a motor vehicle.

This embodiment or other embodiments can also include a pre-mixer which further comprises mixing elements.

These said mixing elements of this pre-mixer can comprise paddles.

This continuous mixer is configured to receive a liquid with a mixed material from said pre-mixer.

This said continuous mixer further comprises mixing elements. These mixing elements of this continuous mixer can comprise paddles and/or screws.

This system can also include at least one scale configured to weigh at least one of the first holding bin and the second holding bin. This at least one scale being configured to weigh material in the holding bin.

There can be at least one computer system, wherein the computer system is configured to read information from the at least one scale and determine an amount of material fed from at least one of the first holding bin and the second holding bin.

The system can also comprise an air pump, and a particulate holding bin. This air pump being coupled to at least one of the first holding bin and the second holding bin, wherein this air pump is configured to pump particulate matter away from at least one of the first holding bin and the second holding bin.

In addition, in at least one embodiment, there can be an additional water cooling system which can be in the form of an external water cooling system or an internal water cooling system.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1 is a side cross-sectional view of one embodiment of the device;

FIG. 2 is a flow chart for the process for mixing and distributing building materials;

FIG. 3 is a block diagram of a computerized system; and

FIG. 4 is a view of an external water cooling system that can also be used to cool the water before it is introduced into the system.

### DETAILED DESCRIPTION OF PREFERRED EMBODIMENTS

At least one embodiment of the invention can relate to a system 10 for delivering building materials comprising a container 11, a transport device coupled to the container 70, wherein the transport device can be configured to couple to a vehicle. In this case, the transport device can in this or in any embodiment be a flat bed for a truck. In addition, the container can be in the form of a standard sized container for a standard sized truck such as an eighteen wheel truck.

Inside the container there can be a first holding bin 12 substantially disposed in the container 11. In addition, there can be a second holding bin 14 substantially disposed in the container 11. There can be at least one feed tube 34 coupled to the first holding bin 12. This feed tube 34 can include a drive system 29 to feed the material through the feed tube 34. The drive system can be in the form of any known drive system, but in this case can be in the form of a screw drive system. There can be at least one other feed tube 32 coupled to the second holding bin 14, this other feed tube can also comprise a drive system 27. This type of drive system can be of any known drive system, such as in the form of a screw drive system. These two holding bins can also each include a vacuum system such as vacuum system 19 or vacuum system 21 which is configured to vacuum up additional particulate matter that has not yet settled.

There can be at least one pre-mixer 42 configured to receive materials from at least one of the feed tubes 32 and 34. The pre-mixer has an input configured to receive an output of the feed tubes 32 and 34 of the first holding bin 12 or the second holding bin 14. This pre-mixer 42 can also be coupled to a weight scale 24 and 26 which are configured to weigh the individual inputs of material such as a first type of material and a second type of material. With this design, the pre-mixer is loaded by first inserting a first type of material, weighing this material individually in the pre-mixer to set a second starting weight and then mixing the second type of material into the pre-mixer. The loading of this second type of material is tracked so that it matches the pre-determined amount or ratio to create a proper solution. Once the ratios are matched in this pre-mixed batch the mixer or drive 40 mixes this batch before dispensing it through a door 42a to the container of continuous mixer 44.

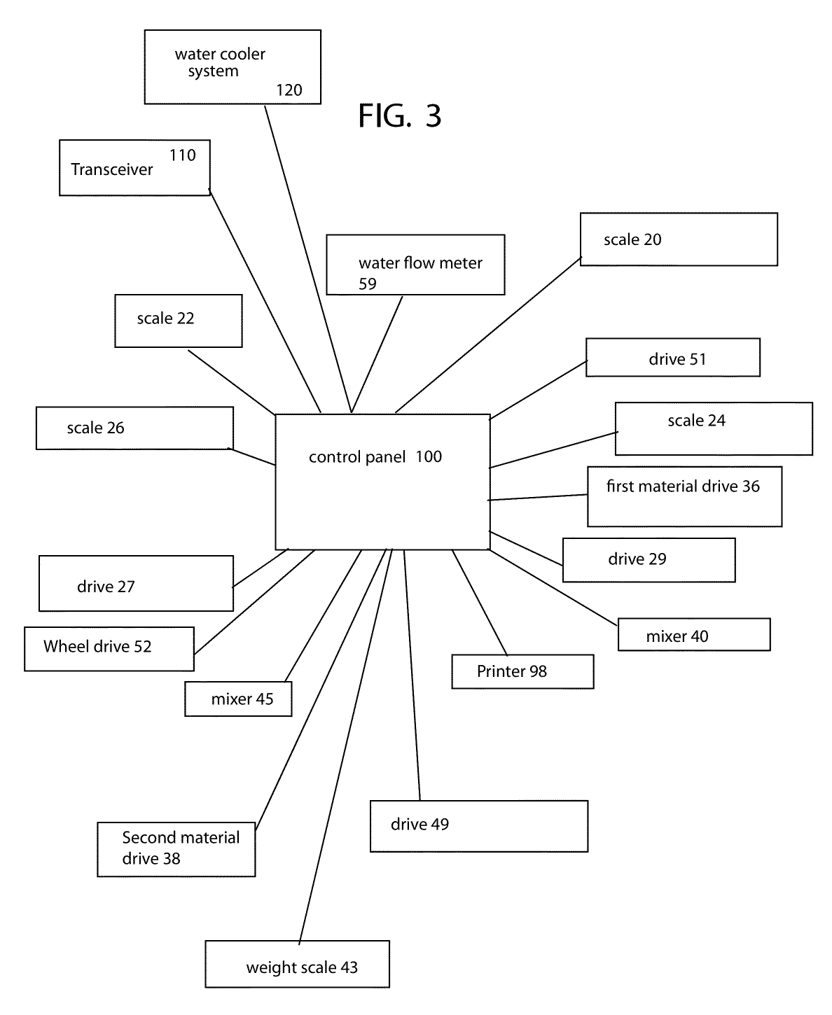

Continuous mixer 44, is configured to receive an output of the pre-mixer 42 and configured to hold the components from the pre-mixer 42. These mixing elements of this pre-mixer can comprise paddles which can be turned to mix the components in the pre-mixer. Alternative mixing elements can be in the form of a screw drive. Continuous mixer 44 is configured to be larger than pre-mixer 42 so that multiple batches of pre-mixer 42 can be inserted into continuous mixer 44. In at least one embodiment, the continuous mixer can be sized by volume to be up to five times larger than pre-mixer 42. In that way there can be a simultaneous batch to continuous mixing process. Thus, multiple batches are transported from mixer 42 into continuous mixer 44 so that the system keeps moving forward to continuously mix multiple batches in continuous mixer 44. At this position in continuous mixer 44 there is still no water added to the system. Mixer 44 also includes a high level sensor 44a, a medium level sensor 44b and a low level sensor 44c to determine whether to add additional batches from pre-mixer 42 into continuous mixer 44. High level sensor 44a, medium level sensor 44b and low level sensor 44c are in communication with a computer or control panel (see FIG. 3) so that the level that this mix is set is communicated to the control panel. Flow rates into each pre-mixer 42 can then be controlled so that the flow up feed tubes 32 and 34 can be controlled to inject the appropriate amount of material at the appropriate pace. In at least one embodiment, the transport device comprises a flat bed 70 with a connection element 60 configured to connect to the vehicle and wherein this vehicle comprises a motor vehicle.

This continuous mixer 44 comprising a mixing bin having an additional mixer device to further mix material from the pre-mixer.

This continuous mixer further comprises mixing elements 45. These mixing elements of this continuous mixer can comprise paddles and/or screws.

This system can also comprise at least one scale such as scales 20 and 22 coupled to their respective holding bins 12 and 14. For example, scale 20 is in communication with computer 100, while scale 22 which is coupled to and configured to weigh holding bin 14 is configured to send the weight of material in holding bin 14 to computer 100. These scales are in communication with a computerized system 100 (See FIG. 3) to track the weight of material moving through the system.

There can be at least one computer system 100 (See FIG. 3), wherein the computer system is configured to read information from at least one of the scales 20, and 22 and determine an amount of material fed from at least one of the first holding bin 12 and the second holding bin 14.

The system can also comprise an air pump 16 and 18 coupled to each of their respective holding bins 12 and 14. Each of these air pumps pump particulate matter that is stirred up in holding bins 12 and 14 into an additional particulate holding bin. For example, there is an air pump 16 coupled to the first holding bin 12 and a second air pump 18 coupled to the second holding bin 14. This air pump is configured to pump particulate matter away from at least one of the first holding bin and the second holding bin.

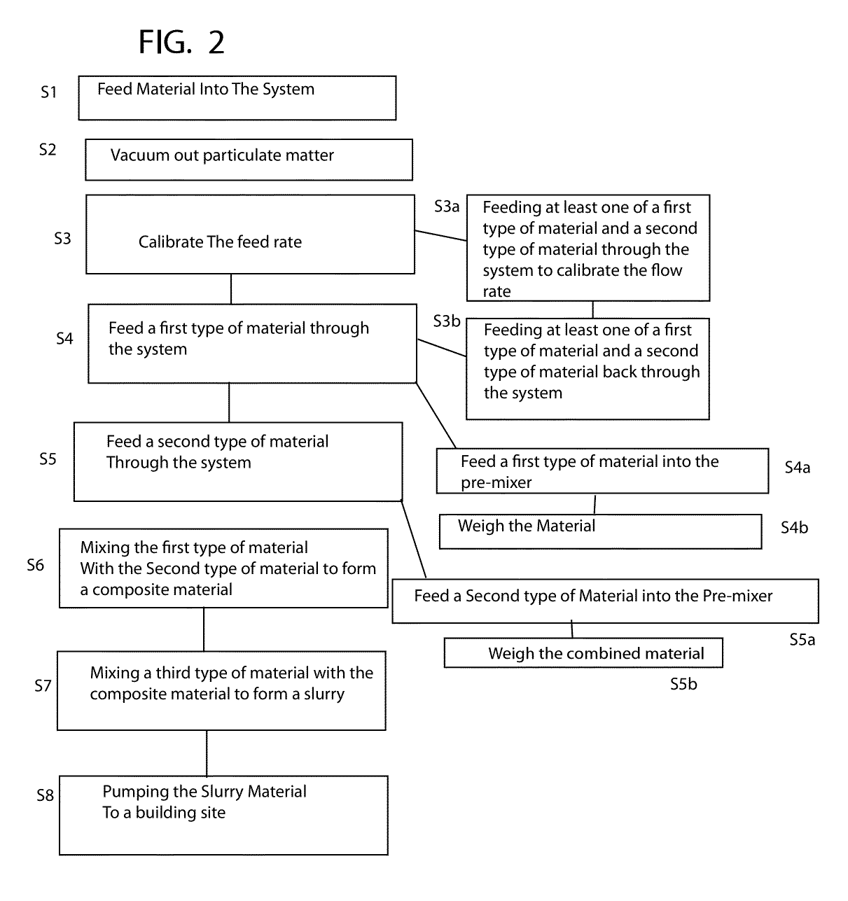

As shown in FIG. 2, one embodiment of the invention relates to a process for continuously feeding building materials to a building site.

This process comprises a first step S1 which includes adding material such as sand and binder to the two different silos such as silo 12 and silo 14. Next, in step S2 any particulate material is vacuumed away. Next in step S3 includes feeding a first type of material through a feeding system. This step includes step S3A which includes feeding a first type of material into a pre-mixer. Next the computer system 100 along with weight scales 24 and 26 weigh the input of this material in step S3b. When a predetermined amount is added to the pre-mixer, the pumping of the first material stops. Next, Step S4 includes feeding a second type of material through the feeding system. This step includes step S4a which includes feeding a second type of material into the pre-mixer 42 after the first type of material is fed therein. Next, in step S4B this material is weighed and when the combined weight reaches a predetermined amount, the pumping of this second material is stopped. This process also includes mixing said first type of material with a second type of material into a composite material in step S5 in pre-mixer 42. Next, in step S6 this dry mixed material is sent as a batch into a holding mixer 44. This holding mixer is capable of storing multiple batches at a single time and also includes a high level sensor 44a, a medium level sensor 44b, and a low level sensor 44c. If the high level sensor 44a indicates that holding bin 44 is filled, then pre-mixer 42 holds off from adding additional material to the mix. However, if medium level sensor 44b or low level sensor 44c indicate that the material is getting low in this holding bin then the pre-mixer is then instructed to either open a pre-mixing door 42a and dump additionally pre-mixed material into the batch, or to continue mixing until the next batch is ready and then dump the pre-mixed material into the holding bin 44.

This process can also include mixing a third type of material with the composite material in step S7. In this process, the mixed batch material is continuously fed into third mixing bin 46 which then results in a third type of material being mixed with the dry mix to create a fluid-type slurry. This third type of material can be a liquid material such as water, a water chemical mixture or any other type of third material.

A next step S8 can include pumping the mixed material to a building site. Because third mixing bin 46 is so small, the previous bin 44 can continuously feed material into bin 46 thereby creating a simultaneous batch-continuous mixing process.

In at least one embodiment, the step of calibrating the feeding system comprises determining a first weight for a material to be mixed, moving the material through the feeding system, tracking the time for feeding the material through the system and then determining a second weight for the material to be mixed. This process can all be tracked by computer system 100.

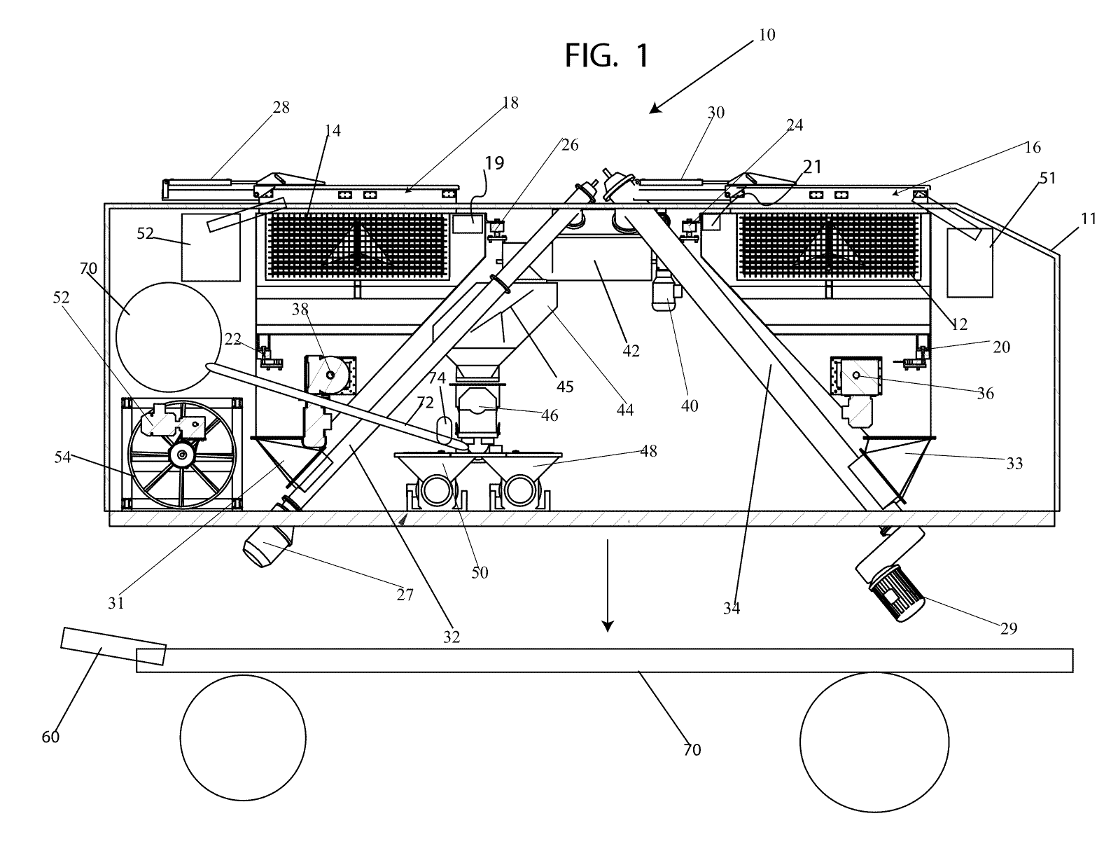

FIG. 3 shows the communication between the computer/control panel 100 and the components of the system which can be controlled by the computer/control panel 100. In this case, there is a direct wireless or wired communication between the remote components and the computer control panel 100. For example scales 20, 22, 24, and 26 are in either wireless or wired communication with computer/control panel 100. This communication allows scales 20, 22, 24 and 26 to communicate the weight that is present within these holding bins 12 and 14 as well as tracking the dynamic weight change that occurs within these holding bins thereby tracking the flow rate of materials from these holding bins. The material is dispersed from these holding bins 12 and 14 via a first material drive 36 for bin 12 and a second material drive 38. These material drives are disposed at a bottom region of bins 12 and 14 (See FIG. 1) such that the material dispensed by bins 12 and 14 is synchronized with the material fed up through silos 32 and 34. Therefore, first material drive 36 is synchronized with drive 29 in silo 34, while second material drive 38 is synchronized with second drive 27 in silo 32 to allow a continuous and even flow of material up these silos.

In addition, mixer 40 which is associated with pre-mixer 42 as well as mixer 45 which is associated with the mixing bin 44, can all be synchronized by computer 100 to control the flow of material through the system. Door 42a can have a mechanical opening system which is configured to open this door when contacted by computer 100.

Furthermore, material from continuous mixing bin 44 can be fed by pump, or drive 46 which feeds mixed material into distribution devices 48 and 50. High level sensor 44a, medium level sensor 44b and low level sensor 44c are configured to send signals to computer or controller 100 so that computer or controller 100 can decide when to open door 42a to distribute more material from pre-mixer 42 into mixing bin 44.

Distribution devices are each driven by respective pumps or drives 52 and 51 which thereby pump material out from the system.

There is also a wireless transceiver 110 which is configured to communicate with other devices such as remote computers or laptop computers which can be used to control control panel 100.

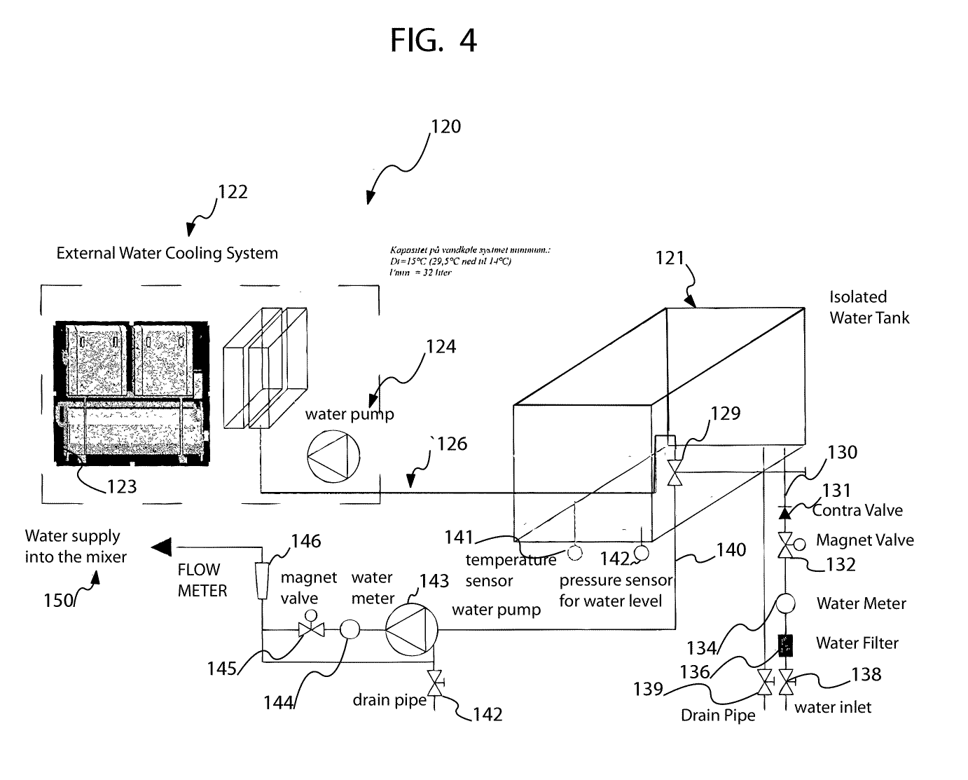

This system can also include a water cooling system. For example, FIG. 4 discloses an external water cooling system which can either be included with the pump truck or housed on a separate truck. The external water cooling system 120 includes an external tank which can be in the form of an isolated water tank 121. Inside of this isolated water tank are two separate water tanks 122, a chiller or compressor 123 and a water pump 124 to pump the water either into or out of the tank along line 126. Compressor 123 is configured to chill the water down to a desired temperature such as approximately, 15 degrees C., or even as low as 14 degrees C. A valve 129 is configured to control the release of water along line 140. In addition water is input into the system via line 130 which allows for an inlet of the water through valve 138, past water filter 136, and water meter 134, through magnet valve 132 and contra valve 131 into the water tanks. Essentially as water enters into pipe 130 it is filtered by water filter 136. The amount of flow is monitored by water meter 134 and this flow is then controlled by valves 132 and 131 into the tanks. Once the water is inside the tanks, the temperature is monitored via temperature sensor 141. In addition, the water level inside of the tanks is monitored via a pressure sensor 142.

Water is dispersed from the tanks via valve 129 which is controlled by the controller in control panel 100. Water then flows along line 140 to ether drain pipe 142 and out drain valve 147, or along line 140 and to water pump 143 which continues to pump the water to water meter 144, past magnet valve 145, and flow meter 146 and out to the water supply for the mixer. The magnet valve can be controlled by the controller so that if the flow meter detects that too much water has flowed, or the water meter detects that the water pressure is too high, then magnet valve can be closed.

This water cooling system can be used to chill the water before it is introduced into the mixer to slow the reaction time of the building materials being mixed in the mixer and to control the temperature of the water introduced into the mixture so that the mixture of building materials and water have a substantially uniform reaction time once the material is mixed and then subsequently poured.

Thus, there is a system which is a computer controlled system wherein once the drives are synchronized for each set of material, the system can operate on a continuous flow system wherein this material is simultaneously batch mixed as well as continuously mixed. Accordingly, while a few embodiments of the present invention have been shown and described, it is to be understood that many changes and modifications may be made thereunto without departing from the spirit and scope of the invention as defined in the appended claims.

What is claimed is:

1. A process for continuously feeding building materials to a building site comprising:
a) feeding a first type of material through a feeding system;
b) feeding a second type of material through the feeding system;
c) mixing said first type of material with a second type of material into a composite material; and
d) mixing a third type of material with said composite material to form a slurry material; and
e) pumping said slurry material to a building site.

2. The process as claimed in claim 1, wherein the process further comprises the step of moving a test batch of at least one type of material through the feeding system to calibrate the feeding rate.

3. The process as claimed in claim 1, wherein this process further comprises the step of calibrating the feeding system by moving a test batch of at least a second type of material through the feeding system.

4. The process as claimed in claim 1, further comprising the step of re-feeding the previously fed test batch of material back into the feeding system.

5. The process as claimed in claim 1, further comprising the step of feeding the second type of test batch material back into the feeding system.

6. The process as claimed in claim 3, wherein said step of calibrating the feeding system comprises determining a first weight for a material to be mixed, moving the material through the feeding system, tracking the time for feeding the material through the system and then determining a second weight for the material to be mixed.

7. The process as claimed in claim 1, further comprising the step of feeding material into the system comprising at least one of sand and binder material.

8. The process as claimed in claim 1, further comprising the step of vacuuming out additional airborne particulate matter and recycling said particulate matter back into the system.

9. A mobile feeding system for building materials comprising:
a) a container;
b) a transport device coupled to said container, said transport device being configured to couple to a vehicle;
c) a first holding bin substantially disposed in said container;
d) a second holding bin substantially disposed in said container;
e) at least one feed tube coupled to said first holding bin;
f) at least one feed tube coupled to said second holding bin;
g) at least one pre-mixer configured to receive materials from said at least one feed tube coupled to said first holding bin, and said at least one feed tube coupled to said second holding bin; and
h) at least one continuous mixer, configured to receive an output of said pre-mixer and configured to hold said components from said pre-mixer.

10. The mobile feeding system as claimed in claim 9, wherein said transport device comprises a flat bed with a connection element configured to connect to said vehicle and wherein said vehicle comprises a motor vehicle.

11. The mobile feeding system as claimed in claim 9, wherein said pre-mixer further comprises mixing elements.

12. The mobile feeding system as claimed in claim 9, wherein said mixing elements of said pre-mixer comprises paddles.

13. The mobile feeding system as claimed in claim 9, wherein said continuous mixer is configured to receive a liquid with a mixed material from said pre-mixer.

14. The mobile feeding system as claimed in claim 13, wherein said continuous mixer further comprises mixing elements.

15. The mobile feeding system as claimed in claim 14, wherein said mixing elements of said continuous mixer comprises paddles.

16. The mobile feeding system as claimed in claim 9, further comprising at least one scale configured to weigh at least one of said first holding bin and said second holding bin, said at least one scale being configured to weigh material in the holding bin.

17. The mobile feeding system as claimed in claim 9, further comprising at least one computer system, said computer system being configured to read information from said at least one scale and determine an amount of material fed from at least one of said first holding bin and said second holding bin.

18. The mobile feeding system as claimed in claim 9, further comprising an air pump, and a particulate holding bin, said air pump being coupled to at least one of said first holding bin and said second holding bin, said air pump being configured to pump particulate matter away from at least one of said first holding bin and said second holding bin.

19. The mobile feeding system as claimed in claim 18, wherein said air pump comprises a vacuum system which is configured to recycle said particulate matter back into the system.

20. The mobile feeding system as claimed in claim 9, further comprising at least one control panel which is configured to control said mixing elements of said pre-mixer and said continuous mixer, and at least one wireless transceiver, which is configured to communicate with a remote computer, and which allows said remote computer to control said at least one control panel.

21. The mobile feeding system as claimed in claim 9, further comprising a water cooling system configured to cool the water before it is supplied to said at least one continuous mixer.
